(19) United States
(12) Patent Application Publication
(10) Pub. No.: US 2006/0214001 A1
(43) Pub. Date: Sep. 28, 2006

(54) Methods for determining operational settings and related devices

(75) Inventors: Cheng Te Chuang, Hsinchu City (TW); Ti-Wen Yuan, Jhubei City (TW); Cheng-Che Chen, Kaohsiung City (TW); Wei Cheng Gu, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/374,823

(22) Filed: Mar. 14, 2006

Related U.S. Application Data
(63) Continuation-in-part of application No. 11/091,166, filed on Mar. 28, 2005.
(63) Continuation-in-part of application No. 11/220,323, filed on Sep. 6, 2005.

(51) Int. Cl. G06K 7/10

(52) U.S. Cl. 235/472.01

(57) ABSTRACT

The present invention relates to a method, applied in a mobile device, for determining operational settings of the device. Country information is retrieved on the device. An operational setting of a function is automatically determined based on the country information. Furthermore, a table comprising a plurality of first fields for recording country information and a plurality of second fields, each of which being corresponding to one first field, for recording output signal formats/exposure time is provided. After the country information on the device is acquired, an output signal format/exposure time of a function on the device is determined based on the country information by looking up the table.

### CROSS-REFERENCE TO RELATED APPLICATION

This application is a Continuation-In-Part of application Ser. No. 11/220,323, filed on Sep. 6, 2005, which is a Continuation-In-Part of application Ser. No. 11/091,166, filed on Mar. 28, 2005.

### BACKGROUND OF THE INVENTION

1. Field of the Invention

The present disclosure relates generally to methods for determining operational settings, and, more particularly to methods for determining operational settings according to location information, and related devices.

2. Description of the Related Art

With the convenience of portable devices, such as mobile phones, smart phones, and PDAs, one can easily carry such devices when traveling. Some functions on the devices, however, are location (e.g. country) related. For example, television signal formats differ by country. In USA, Canada, Japan, South Korea, Mexico, Philippines, Taiwan, and others, the TV signal format is NTSC (National Television System Committee). In Australia, China, Germany, Hong Kong, Singapore, and others, the TV signal format is PAL (Phase Alternation by Line). In France, Egypt, Iran, Vietnam, and others, the TV signal format is SECAM (Systeme Electronique Couleur Avec Memoire). If a portable device with TV-related functions is carried from USA to China, its TV signal format must be changed from NTSC to PAL, otherwise the portable device may not operate properly with a TV. Conventionally, the necessary changes in operational settings of portable devices are performed manually using certain user interfaces, which is inconvenient and time-consuming.

### BRIEF SUMMARY OF THE INVENTION

Methods for determining operational settings and related devices are provided.

In an exemplary embodiment of a method for determining operational settings, country information is retrieved on a device. An operational setting of a function on the device is determined based on the country information.

In another exemplary embodiment of a device, means for retrieving/acquiring first country information; and means for determining an operational setting of a function on the device based on the first country information are provided.

In another exemplary embodiment of a method for determining output signal format/exposure time of a function for use in a device, a table comprising a plurality of first fields for recording country information and a plurality of second fields, each of which being corresponding to one first field, for recording output signal formats/exposure time is provided. Then, country information on the device is acquired, and an output signal format/exposure time of a function on the device is determined based on the country information by looking up the table.

Another exemplary embodiment of a system comprises a GPS satellite, a mobile station, and a GPS server. The GPS satellite broadcasts GPS signals. The mobile station receives the GPS signals from the GPS satellite, and sends the GPS signals to the GPS server. The GPS server calculates position information accordingly, determines country information according to the position information, and sends the country information to the mobile station.

Another exemplary embodiment of a mobile station comprises a communication unit, and a processor. The communication unit listens to a control channel provided by a communication network, and receives system information of the communication network from the control channel. The processor retrieves country information from the system information, and determines an operational setting of a function on the mobile station based on the country information.

Another exemplary embodiment of a device comprises a GPS antenna, a GPS receiver, and processor. The GPS receiver receives and decodes the positioning signals broadcasted by GPS satellites via the GPS antenna, and calculates position information accordingly. The processor retrieves country information according to the position information, and determines an operational setting of a function on the mobile station based on the country information.

Another exemplary embodiment of a mobile station comprises a communication unit, and a processor. The communication unit listens to a control channel provided by a communication network, and receives system information of the communication network from the control channel. The processor retrieves country information from the system information, and determines proper exposure times for capturing images using an image sensor based on the country information.

Another exemplary embodiment of a device comprises a GPS antenna, a GPS receiver, and processor. The GPS receiver receives and decodes the positioning signals broadcasted by GPS satellites via the GPS antenna, and calculates position information accordingly. The processor retrieves country information according to the position information, and determines proper exposure times for capturing images using an image sensor based on the country information.

Methods for determining operational settings may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a device;

FIG. 2 is a schematic diagram illustrating an embodiment of a device;

FIG. 3 is a flowchart showing an embodiment of a method for determining operational settings;

FIG. 4 is a flowchart showing an embodiment of a method for retrieving country information;

FIG. 5 is a flowchart showing an embodiment of a method for retrieving country information;

FIG. 6 is a flowchart showing an embodiment of a method for retrieving country information;

FIG. 7 is a flowchart showing an embodiment of a method for determining output signal format;

FIG. 8 is a schematic diagram illustrating an embodiment of a preferred signal format table;

FIG. 9 is a flowchart showing an embodiment of a method for system time adjustment;

FIG. 10 is a flowchart showing an embodiment of a method for determining exchange rates;

FIG. 11 is a schematic diagram illustrating an embodiment of a time zone table;

FIG. 12 is a schematic diagram illustrating an embodiment of a currency value table;

FIG. 13 is a schematic illustrating a camera mobile phone system;

FIG. 14 is a flowchart showing an embodiment of a method for determining exposure time;

FIG. 15 is a schematic diagram illustrating an embodiment of a lamp flicker frequency table;

FIG. 16 is a schematic diagram illustrating an embodiment of an exposure time table;

FIG. 17 is a schematic diagram illustrating an embodiment of system for obtaining country information;

FIG. 18 is a schematic diagram showing the structure of a mobile phone system for determining output signal format;

FIG. 19 is a schematic diagram showing the structure of a mobile phone system for system time adjustment;

FIG. 20 is a schematic diagram showing the structure of a mobile phone system for system time adjustment; and

FIG. 21 is a flowchart showing an embodiment of a method for setting camera mode.

### DETAILED DESCRIPTION OF THE INVENTION

Methods for determining operational settings and related devices are provided.

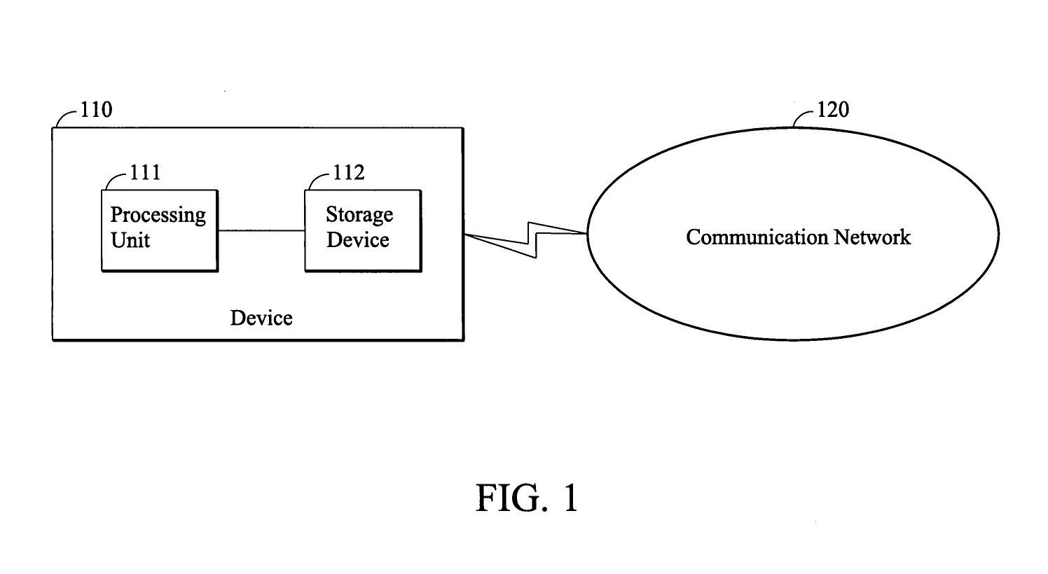

FIG. 1 is a schematic diagram illustrating a device 110 according to an embodiment of the present invention. The device 110 may be a portable device, such as a mobile phone. It is understood that the mobile phone is used in the embodiments, but not limited thereto. The device 110 comprises a processing unit 111 and a storage device 112. The processing unit 111 performs related operation and related determination of the present invention. The storage device 112 stores operational settings of functions. The operational settings depend on the functions. For example, the operational setting may be the TV signal format for the TV output function. The operational setting may be system time, exchange rates, exposure time, and others. The storage device 112 further stores related tables for looking up operational settings for specific functions. The tables will be discussed later. The device 110 communicates with a communication network 120, such as a telecommunication system, which may be a Global System for Mobile Communications (GSM), General Packet Radio Service (GPRS), Enhanced Data rates for Global Evolution (EDGE), or Universal Mobile Telecommunications System (UMTS) cellular network, or other network. The device 110 receives system information from the communication network 120, and retrieved country information accordingly. Operating settings related to the country information can be stored in the storage device 112.

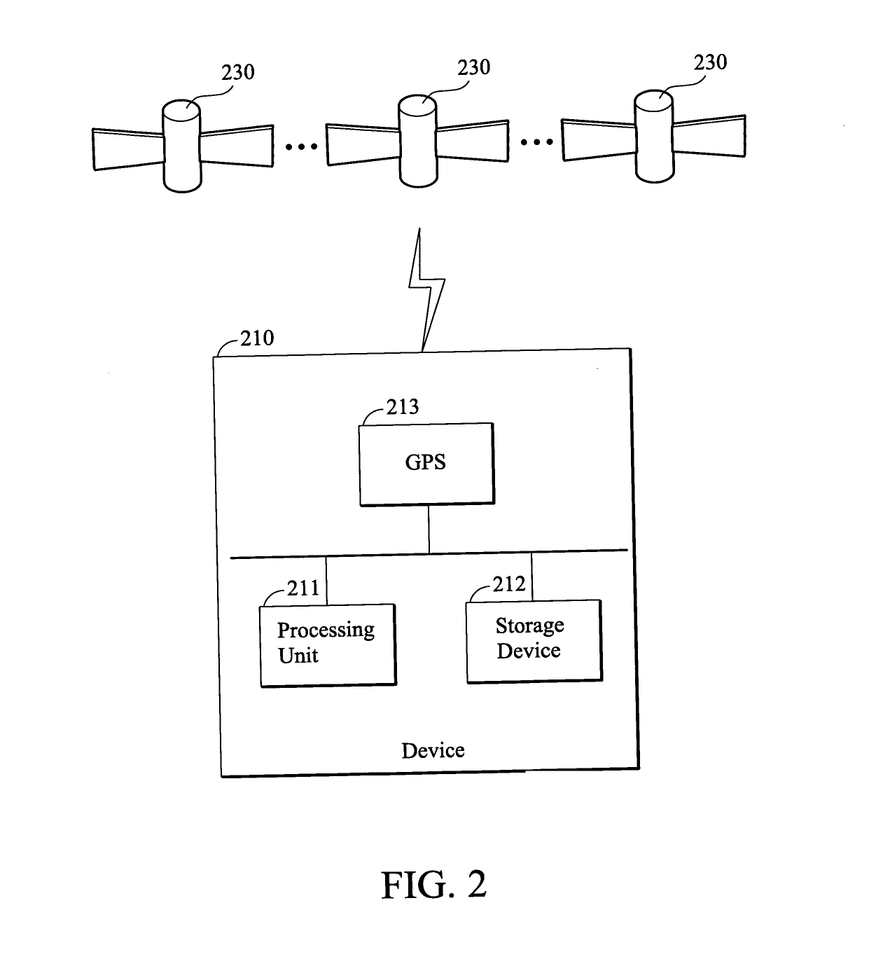

FIG. 2 is a schematic diagram illustrating a device 210 according to another embodiment of the present invention. The device 210 may be a portable device, such as a mobile phone or a PDA (Personal Digital Assistant). The device 210 comprises a processing unit 211, a storage device 212, and a GPS (Global Positioning System) receiver 213. Similarly, the processing unit 211 performs related operation and determination of the device 210. The storage device 212 stores operational settings of functions and related tables for looking up operational settings for specific functions. The GPS receiver 213 can receive and decode signals from a plurality of GPS satellites 230, and calculates position information accordingly, such as the longitude and the latitude of the device 210. It is understood that the number of the GPS satellites 230 must exceed 4. The device 210 determines location (e.g. country) information according to the position information. Operating settings that are related to the country information can be stored in the storage device 212.

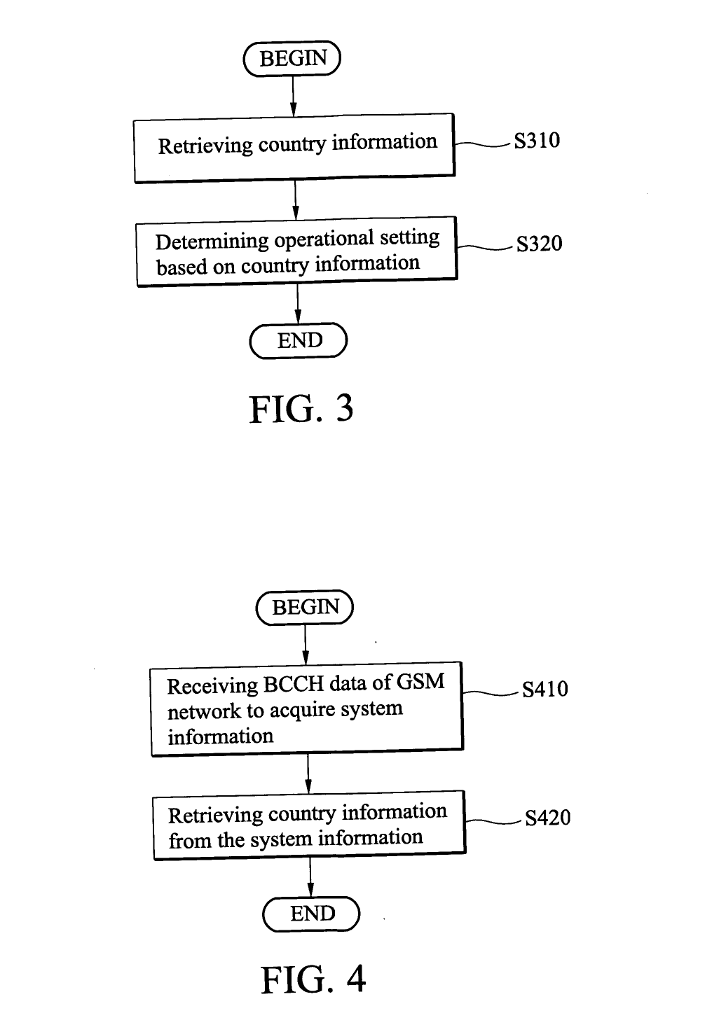

FIG. 3 is a flowchart showing an embodiment of a method for determining operational settings. In step S310, country information is retrieved. Then, in step S320, the operational setting of a specific function is determined based on the country information.

Several methods of retrieving country information (implemented in S310) are provided.

FIG. 4 is a flowchart showing an embodiment of a first method for retrieving country information. The first method can be applied in the device 110. In step S410, the device 110 receives the Broadcast Control Channel (BCCH) provided by the GSM communication network 120, and obtains system information from the channel. It is understood that the GSM communication network, broadcasts certain system information in BCCH, from which mobile stations (device) can acquire system information for further calculation and processing. One of the system information broadcasted on BCCH is the Location Area Identifier (LAI) comprising a country code, a communication network code, and a location area code. Then, in step S420, country information, such as the country code in the Location Area Identifier is retrieved from the system information. It is also understood that BCCH is used in a GSM communication network to broadcast system information including the location information. Other communication networks, such as the third generation (3G) communication network may broadcast the location information in other channels.

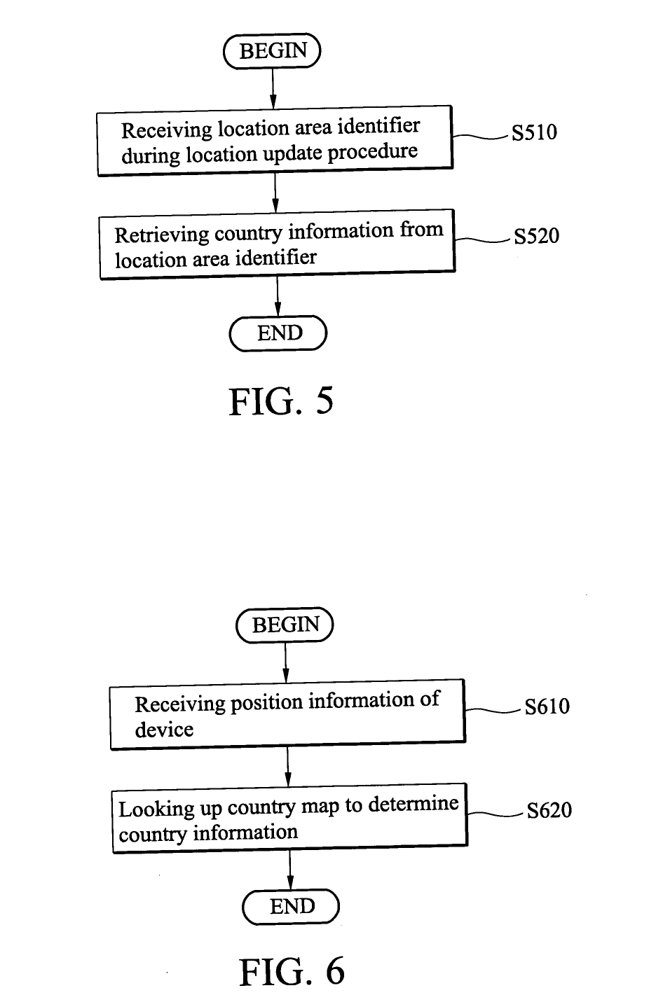

FIG. 5 is a flowchart showing an embodiment of a second method for retrieving country information. The second method can be applied in the device 110. In step S510, the device 110 receives a location area identifier from the communication network 120 during location update procedures between the device 110 and the communication network 120. The location update procedures may occur during the registration of the device 110 to the communication network 120. Similarly, the location area identifier comprises a country code, a communication network code, and a location area code. Then, in step S520, country information, such as the country code is retrieved from the location area identifier.

FIG. 6 is a flowchart showing an embodiment of a third method for retrieving country information. The third method can be applied in the device 210. In step S610, the GPS receiver 213 of the device 210 receives signals from GPS satellites 230. The signals are decoded to calculate the position information, such as the longitude and latitude of the device 210. Then, in step S620, a country map (not shown) is looked up to determine country information according to the position information.

In an embodiment of a country map, the contours of respective countries in longitude and latitude are recorded. Once the position information, such as longitude and latitude of the device 210 is acquired, it is determined whether the longitude and latitude falls into any contours of a country. If so, the country is determined. In another embodiment of a country map, one or more circular regions are recorded for each country. Each circular region has a radius and longitude and latitude. Once the position information, such as longitude and latitude of the device 210 is acquired, it is determined whether the longitude and latitude falls into any circular region of a country. If so, the country having the circular region that the longitude and latitude falls into is determined. It is understood that the finer the circular regions are, the more accurate the country determination will be. In still another embodiment of a country map, one or more rectangular regions are recorded for each country. Each rectangular region is defined by longitudes and latitudes at its corners. Once the position information, such as longitude and latitude of the device 210 is acquired, it is determined whether the longitude and latitude falls into any rectangular region of a country. If so, the country having the rectangular region that the longitude and latitude falls into is determined. Similarly, the finer the rectangular regions are, the more accurate the country determination will be.

In some embodiments, the country information can be retrieved in the device 210. That is the country map is stored in the device 210, and the generation of position information, and determination of country information using the position information and the country map are performed in the device 210. In some embodiments, the generation of position information, and determination of country information can be performed by a GPS server. FIG. 17 is a schematic diagram illustrating an embodiment of system for obtaining country information. As shown in FIG. 17, when a MS 1710 such as a mobile phone receives signals from GPS satellites 1740, the MS 1710 sends the signals to a GPS server 1730 via a base station 1720. The GPS server 1730 comprises a calculation unit 1731 and memory. 1732 comprising a country map 1733. The calculation unit 1731 calculates position information, such as the longitude and latitude of the MS 1710, and looks up the country map 1733 to determine the country information according to the position information. Then, the GPS server 1730 sends the country information to the MS 1710 via the base station 1720. It is understood that data transmission between the base station 1720 and the GPS server 1730 can be through the Internet or a cellular network.

It is understood that the country information can be set via an interface, for example a LCD display and a key pad (not shown), of the device 110/210 by a user. Furthermore, in some embodiments, after the device obtains the country information, the device can show the obtained country information on the interface for the user to confirm. If the user thinks the obtained country information is incorrect, the user can override and select a different country via the interface.

Additionally, the country information can be also derived from the city information set via an interface, for example a LCD display and a key pad (not shown), of the device 110/210 by the user. For example, when traveling from one country to another, the user may change the time zone of the device 110/210 manually by selecting the destination city from a city list provided in the device 110/210. The device 110/210 has a mapping table (not shown) associating a specific city to its corresponding country information, thus the device 110/210 can base on the user's city selection to obtain the country information by looking up the mapping table.

Several examples of operational setting determination for specific functions (implemented in S320) are provided.

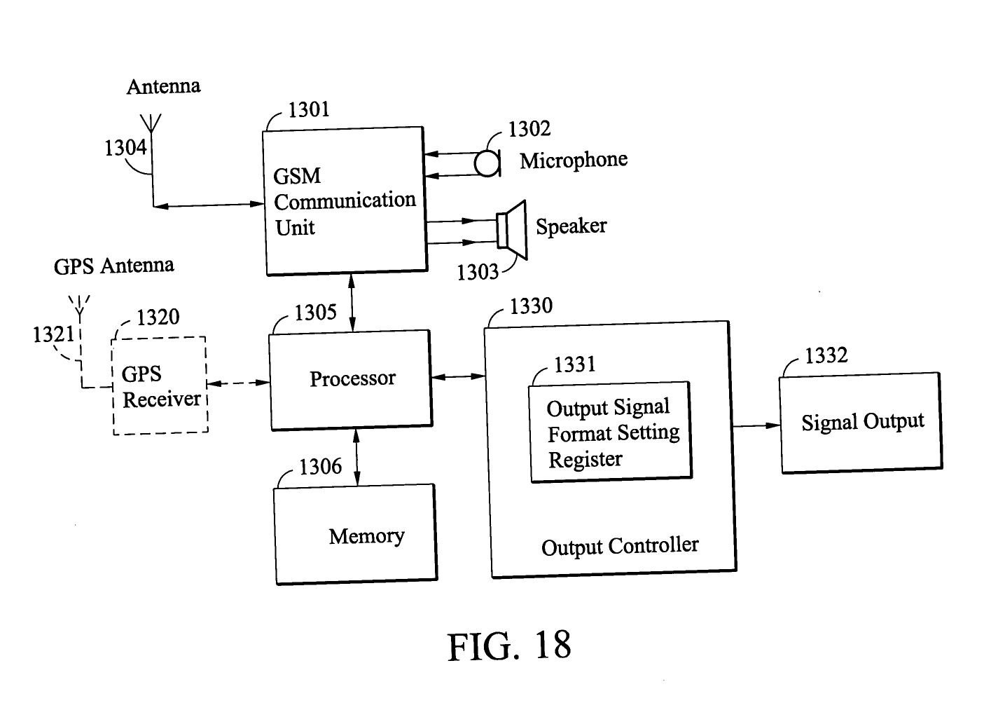

FIG. 18 is a schematic diagram showing the structure of a mobile phone system for determining output signal format. For the purpose of simplification and without loss of generality, the GSM cellular phone system is described here for exemplification. A GSM communication unit 1301 is for performing wireless communication. The GSM communication unit 1301 converts speech signals received by a microphone 1302 to outgoing radio signals. Furthermore, the GSM communication unit 1301 converts incoming radio signals to speech signals to be outputted by the speaker 1303. Besides speech signals, control messages or other information as required by the GSM standard are also transmitted and received by the GSM communication unit 1301. An antenna 1304 converts the outgoing radio signal to electromagnetic radiation, as well as converting the incoming electromagnetic waves to radio signal that is processed by the GSM communication unit 1301. The operation of the GSM communication unit 1301 is controlled by a processor 1305, which executes software programs stored in a memory 1306.

An output controller 1330 is controlled by the processor 1305 to perform signal output operation. The output controller 1330 comprises an output signal format setting register 1331 for output signal format setting. The processor 1305 can change the output signal format by programming the output signal format setting register 1331.

A GPS receiver 1320 and a GPS antenna 1321 are optional. If they exist, the GPS receiver 1320 can receive and decode the position signals broadcasted by the GPS satellites via the GPS antenna 1321, and accordingly generate coordinate data indicating the location of the mobile phone system on earth. The coordinate data outputted by the GPS receiver 1320 is accessible to processor 1305, which can control the output signal format setting according to the coordinate data.

In the system in FIG. 18, country or location information can be obtained from the GSM cellular network using the GSM communication unit 1301 or from the GPS satellites via the GPS antenna 1321 and GPS receiver 1320.

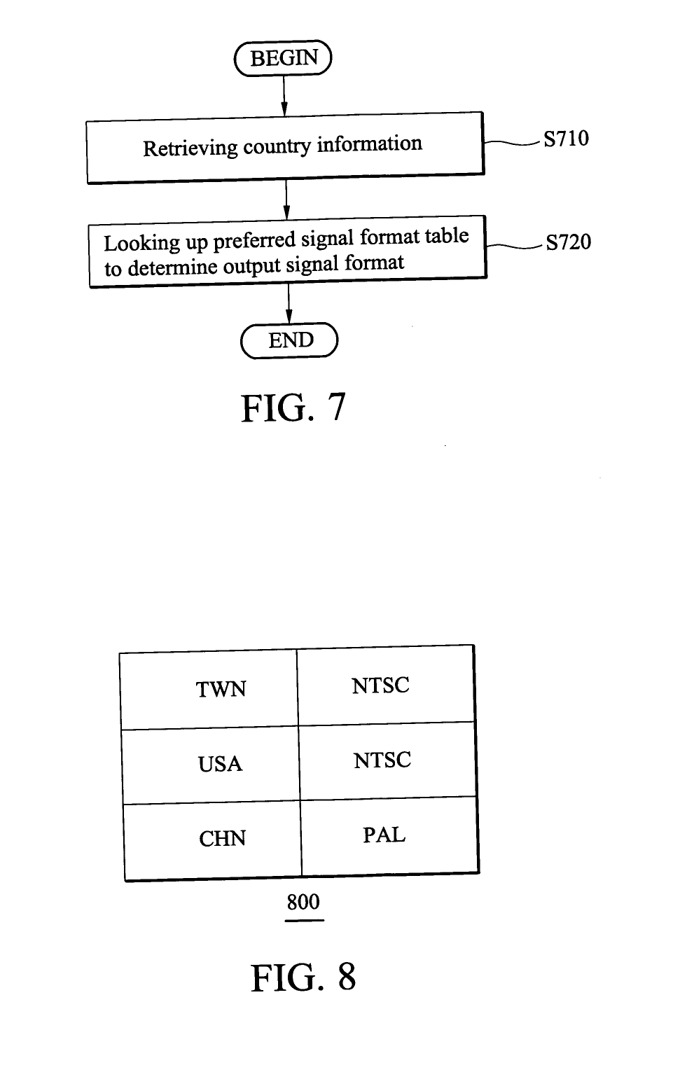

FIG. 7 is a flowchart showing an embodiment of a method for determining output signal format in the system shown in FIG. 18. In step S710, country information is retrieved. It is understood that the country information can be retrieved according to the location area identifier (referring to FIG. 4 and FIG. 5) or the position information of the device 210 (referring to FIG. 6), and is not limited thereto. In step S720, a preferred signal format table is looked up to determine a specific output signal format according to the country information. FIG. 8 is a schematic diagram illustrating an embodiment of a preferred signal format table 800. The table 800 comprises a plurality of first fields for strong country codes, and a plurality of second fields. Each of the second fields corresponds to a first field for storing TV output video signal format(s) acceptable in the country represented by the corresponding country code. As shown in FIG. 8, the TV output video signal formats for Taiwan (TWN), America (USA) and China (CHN) are NTSC, NTSC and PAL, respectively. If the retrieved country information regards Taiwan, the TV output video signal format is automatically determined to be NTSC. It is understood that if several formats are acceptable in a country, all of the formats may be stored in the preferred signal format table, and the most widely used format can be set as a default format. In some embodiments, the device 110 may show all of the acceptable formats on the interface for user selection.

As described above, a country map may be represented in one or more circular regions. In some embodiments, if the country information is determined according to the position information of the device 210, the area of a circular region may be the transmission area of a TV transmitter. In this way, the setting for output signal format will be more accurate.

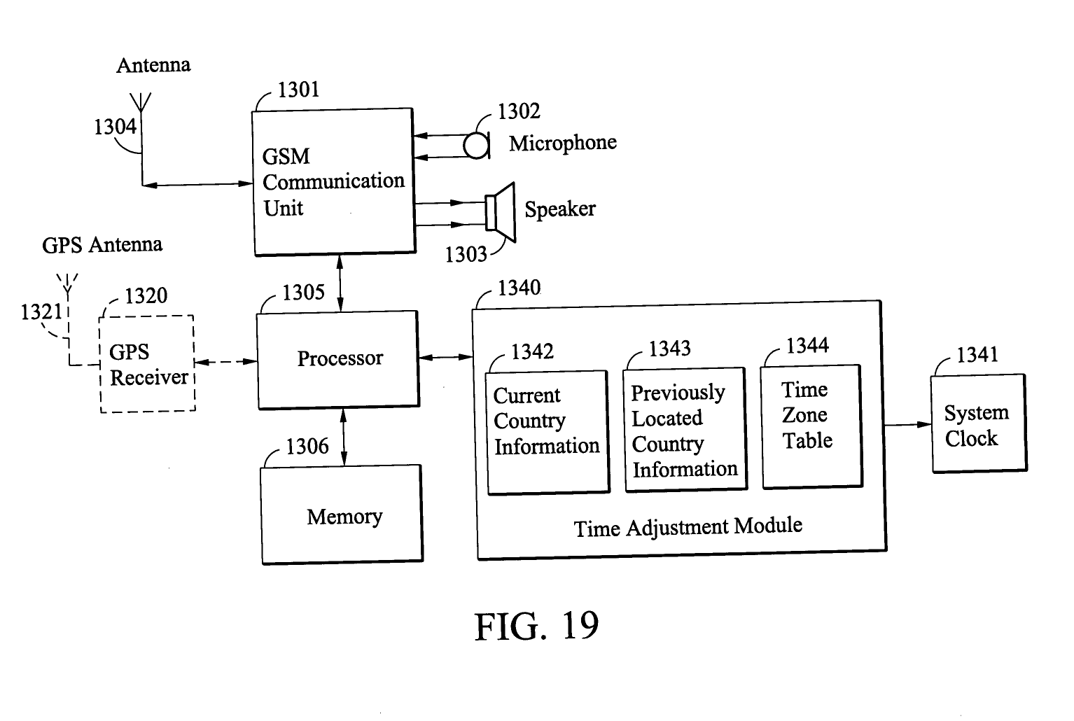

FIG. 19 is a schematic diagram showing the structure of a mobile phone system for system time adjustment. Similarly, for the purpose of simplification and without loss of generality, the GSM cellular phone system is described here: for exemplification. The difference between the mobile phone system in FIG. 19 and that in FIG. 18 is the mobile phone system in FIG. 19 comprises a time adjustment module 1340 for adjusting the system time of a system clock 1341. Other components in FIG. 19 having the same reference numbers as those in FIG. 18 have the same functions, and the description for those components is omitted for avoiding redundancy.

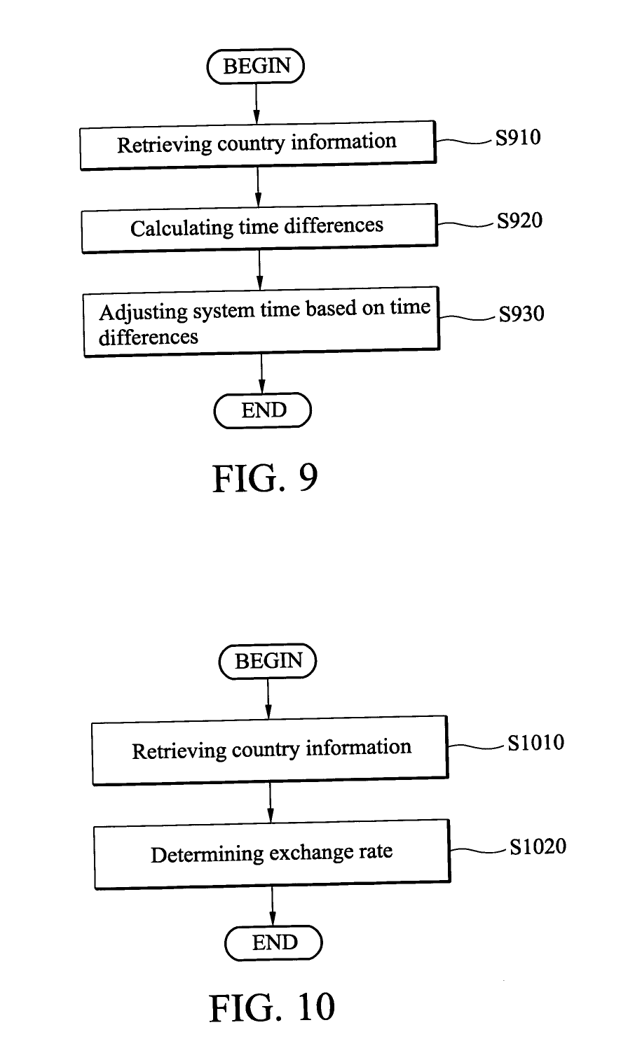

The time adjustment module 1340 is controlled by the processor 1305 to perform time adjustment. The time adjustment module 1340 comprises current country information 1342, previously located country information 1343, and a time zone table 1344. The time zone table 1344 comprises a plurality of first fields for storing country codes, and a plurality of second fields. Each of the second fields corresponds to a first field for storing time zone(s) (standard time) where the country represented by the corresponding country code is located and covers. The adjustment module 1340 adjusts the system time of the system clock 1341 according to the current country information 1342, the previously located country information 1343, and the time zone table 1344. The detail of time adjustment is discussed in FIG. 9.

Similarly, the GPS receiver 1320 and the GPS antenna 1321 are optional in the mobile phone system of FIG. 19. If they exist, the processor 1305 uses the coordinate data outputted by the GPS receiver 1320 to perform the time adjustment according to the coordinate data.

Similarly, in the system in FIG. 19, country or location information can be obtained from the GSM cellular network using the GSM communication unit 1301 or from the GPS satellites via the GPS antenna 1321 and the GPS receiver 1320.

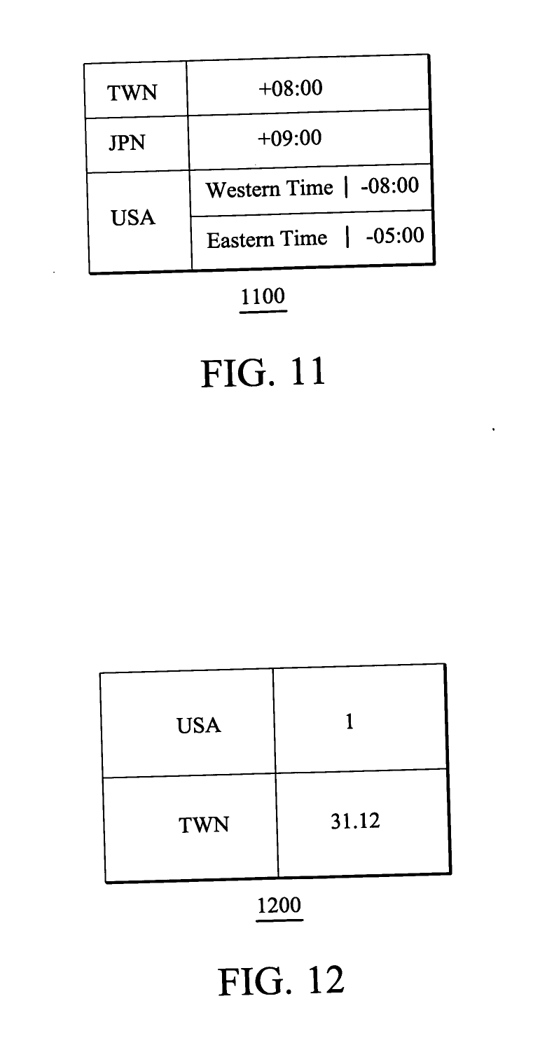

FIG. 9 is a flowchart showing an embodiment of a method for system time adjustment in the system shown in FIG. 19. In step S910, country information is retrieved. It is understood that the country information can be retrieved according to the location area identifier (referring to FIG. 4 and FIG. 5) or the position information of the device 210 (referring to FIG. 6), and is not limited thereto. In step S920, time difference is calculated according to the current country corresponding to the retrieved country information and a country that the device 110/210 previously located. It is understood that the country that the device 110/210 previously located can be obtained from the storage device 112/212. Furthermore, the device 110/210 has a time zone table 1100, as shown in FIG. 11. The time zone table comprises a plurality of first fields for storing country codes, and a plurality of second fields. Each of the second fields corresponds to a first field for storing time zone(s) (standard time) where the country represented by the corresponding country code is located and covers. It is understood that if several time zones are in the current country, a selection of time zones or cities corresponding to time zones can be provided for the user. As shown in FIG. 11, the standard time for country code TWN (representing Taiwan) is +08:00, the standard time for country code JPN (representing Japan) is +09:00, and the standard time for the Western portion of country code USA is −08:00, and for the Eastern portion of country code USA is −05:00. Since the USA has several time zones, corresponding cities (not shown) can be further recorded in the table 1100 for user selection. By looking up the time zone table, the standard time for the current country and the standard time for the previously located country are obtained, thus, the time difference therebetween can be calculated. Then, in step S930, the system time of the device 110/210 is adjusted based on the time difference between the two countries. For example, if a device roams from Taiwan to Japan, one hour is added to the system time of the device.

It can be easily understood that as for the device 210 having the GPS receiver 213, the information of time zone can be provided according to the position information, i.e. the longitude and latitude of the device 210.

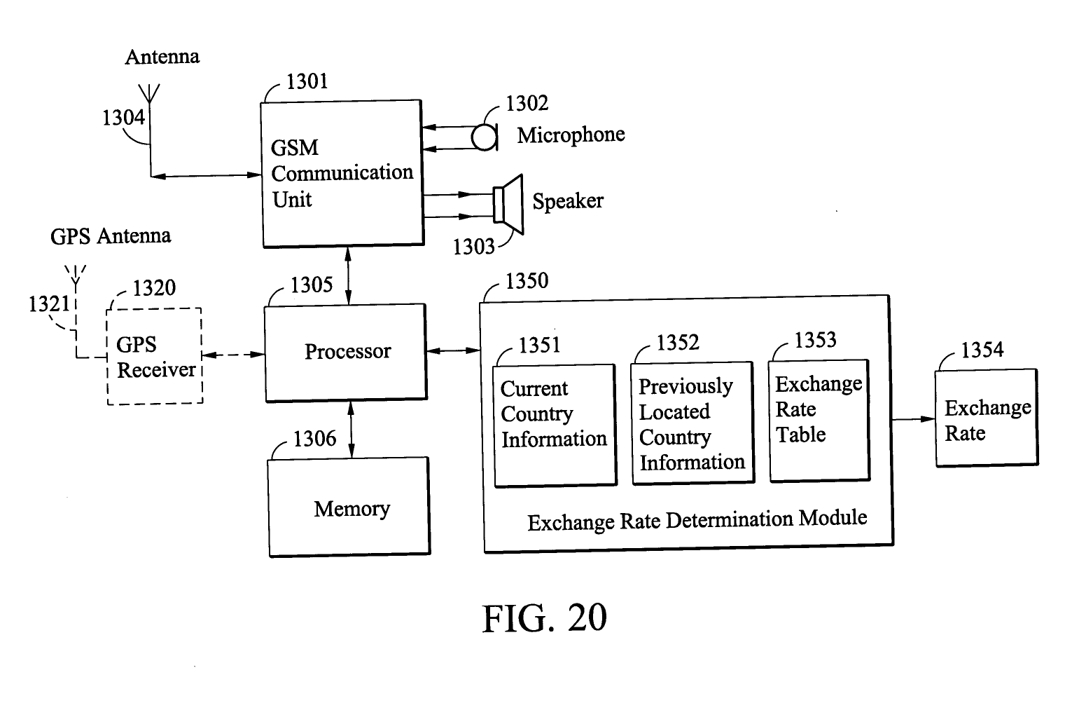

FIG. 20 is a schematic diagram showing the structure of a mobile phone system for determining exchange rates. Similarly, for the purpose of simplification and without loss of generality, the GSM cellular phone system is described here for exemplification. The difference between the mobile phone system in FIG. 20 and that in FIG. 18 is the mobile phone system in FIG. 20 comprises an exchange rate determination module 1350 for determining exchange rates. Other components in FIG. 20 having the same reference numbers as those in FIG. 18 have the same functions, and the description for those components is omitted for avoiding redundancy.

The exchange rate determination module 1350 is controlled by the processor 1305 to determine exchange rates. The exchange rate determination module 1350 comprises current country information 1351, previously located country information 1352, and an exchange rate table 1353. The exchange rate table 1353 comprises a plurality of first fields for storing country codes, and a plurality of second fields. Each of the second fields corresponds to a first field for storing the exchange rate between the circulated currency in the country represented by the corresponding country code and a specific country dollar, such as the United States dollar. The exchange rate determination module 1350 determines an exchange rate 1354 according to the current country information 1351, the previously located country information 1352, and the exchange rate table 1353. The detail of exchange rate determination is discussed in FIG. 10.

Similarly, the GPS receiver 1320 and the GPS antenna 1321 are optional in the system of FIG. 20. If they exist, the processor 1305 uses the coordinate data outputted by the GPS receiver 1320 to determine the exchange rates according to the coordinate data.

Similarly, in the system of FIG. 20, country or location information can be obtained from the GSM cellular network using the GSM communication unit 1301 or from the GPS satellites via the GPS antenna 1321 and the GPS receiver 1320.

FIG. 10 is a flowchart showing an embodiment of a method for determining exchange rates in the system shown in FIG. 20. In step S1010, country information is retrieved. It is understood that the country information can be retrieved according to the location area identifier (referring to FIG. 4 and FIG. 5) or the position information of the device 210 (referring to FIG. 6), and is not limited thereto. In step S1020, an exchange rate between the circulated currency in the current country corresponding to the retrieved country information and that in a country that the device 110/210 previously located is determined. It is understood that the country that the device 110/210 previously located can be obtained from the storage device 112/212. Furthermore, the device 110/210 has an exchange rate table 1200, as shown in FIG. 12. The exchange rate table 1200 comprises a plurality of first fields for storing country codes, and a plurality of second fields. Each of the second fields corresponds to a first field for storing the exchange rate between the circulated currency in the country represented by the corresponding country code and the United States dollar. In FIG. 12, the exchange rate for country code USA is 1 since the exchange rate between the circulated country in United States and US dollar (exchange rate USA/USA) is 1, while that for country code TWN is 31.12 since the exchange rate between the circulated country in Taiwan and US dollar (exchange rate TWN/USA) is 31.12. By looking up the currency table 1200, the exchange rate between the circulated currency in the current country and US dollar together with that between the circulated currency in the previously located country and US dollar are obtained, thus, the exchange rate between the circulated currency in the current country and that in the previously located country can be calculated. In some embodiments, the information provided in the exchange rate table can be dynamically updated via the communication network 120.

Digital camera function is becoming a popular application on mobile phones nowadays. In such a mobile phone a digital camera module is included, thus allows the user to take photographs or videos conveniently. The imaging principle of digital cameras is similar to that of conventional film cameras. The reflected light from objects is focused inside the camera via optical lens onto an imaging device. For a film camera, the reflected light causes a chemical change to the photographic material coated on the film, and the film need be developed after the darkroom process to obtain photos. For a digital camera, the imaging device is a light-sensitive semiconductor device called image sensor. When the image sensor is exposed to input light focused by the lens, the image sensor converts the light into electric charges representative of the light intensity. The electric charge strength is then read out and processed by an image processor to reconstruct the image captured by the sensor. Usually the reconstructed image data is further compressed to reduce its size, and eventually is stored as a computer readable file, such as a JPEG (Joint Photographic Experts Group) file, to a storage media.

Two types of image sensors are commonly used in digital cameras: CCD (Charge Coupled Device) and CMOS (Complementary Metal Oxide Semiconductor) image sensors. Inside both types of sensors are large arrays composing of rows of photo-sensitive elements (called pixel), each of which is capable of recording the incoming light intensity electrically. To obtain a complete image captured by the image sensor, the rows of pixels are read out one by one by an image processor, where the pixel data are processed to reconstruct the captured image.

CMOS image sensors usually consume less operating power than CCD sensors, thus are widely used in cameras in mobile phones. Furthermore, due to size and cost considerations, a light exposure method called rolling shutter is often employed. In an image sensor exposed by rolling shutter, a few rows of pixels are exposed at one time. A complete image is built by

1. Reading the most exposed row of pixels, and then deactivating the row to stop its exposure;

2. Starting the exposure of the next unexposed row adjacent to the exposed ones;

3. Repeating the above steps on the next most exposed row and the next unexposed row, until all rows of the image sensor are read out.

During the exposure period, each pixel of the exposed rows accumulates its incoming light energy in the form of electrical charge. The accumulated electrical charge will be stronger if the incoming light is brighter and the exposure time is longer.

In an image sensor using rolling shutter, the rows of the sensor are exposed sequentially. To make the captured image looked smooth and natural, the light source should have constant luminance during the exposure periods of all rows of the image sensor. If, on the contrary, the luminance of the light source varies with time, the rows of the image sensor will pick up the change in luminance. As a result, the captured image will exhibit bands of different brightness, which phenomenon is called banding.

It is known that some lamps, such as conventional fluorescent lamps and incandescent lamps, flicker at a frequency twice the AC power line frequency. This effect, which is caused by the voltage fluctuation of the power source, is called lamp flicker. For example, in the United States the AC power frequency is 60 Hz, thus lamps would flicker at 120 Hz. In China, where a 50 Hz AC power is used, the lamp flicker frequency would be 100 Hz. When a camera with image sensor adopting rolling shutter is used in an environment illuminated with flickering lamps, banding could be severe because the lamps are generating unsteady light energy over the exposure periods of sensor rows.

A technique known to the industry which can reduce banding is to set the exposure time of the image sensor to a multiple of the reciprocal of the lamp flicker frequency. For example, in the United States to reduce the banding effect, the exposure time of the rolling shutter image sensor should be set to a multiple of 1/120 second, such as 1/120 second, 1/60 second and 1/30 second, whereas in China, exposure time should be set to a multiple of 1/100 second, such as 1/100 second, 1/50 second and 1/25 second.

Since the lamp flicker frequency is generally related to the AC power line frequency which differs by regions, to avoid banding the exposure time of a camera needs to be properly set whenever it is used. For a camera mobile phone that may be used in many places in the world, manually setting the camera sensor exposure timing would be troublesome to the user. Besides, the user may not be knowledgeable of the proper setting so wrong exposure timing could be selected. Therefore, the present invention discloses methods that change or help to change the camera exposure time setting based on the location or country information.

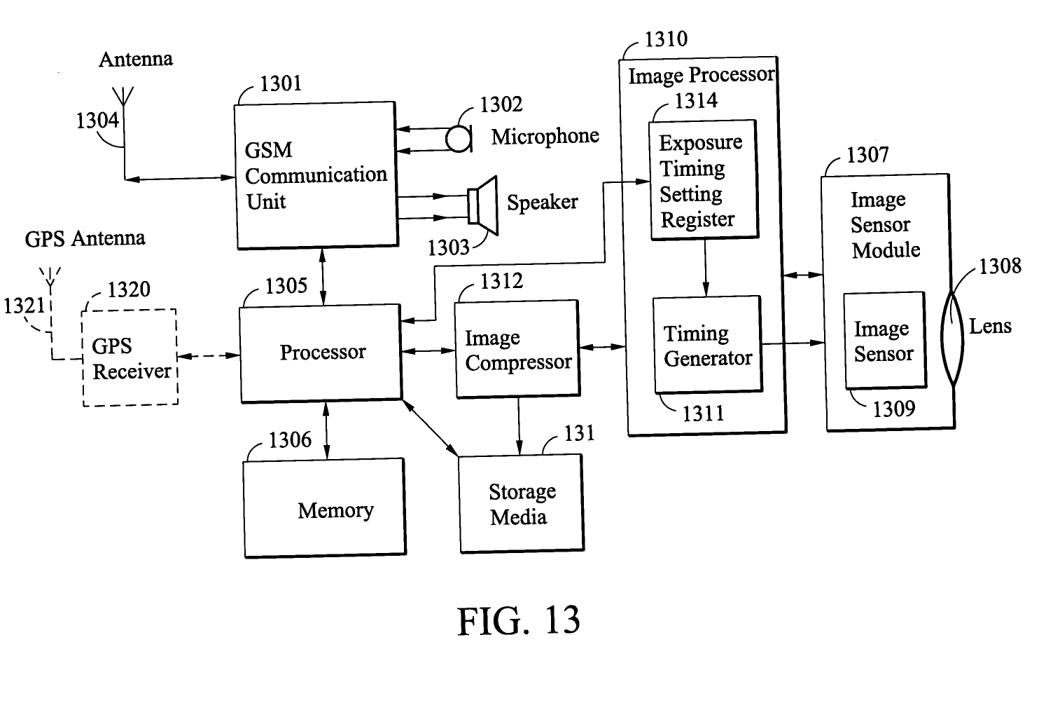

FIG. 13 is a schematic diagram showing the structure of a camera mobile phone system. Similarly, for the purpose of simplification and without loss of generality, the GSM cellular phone system is described here for exemplification. The difference between the mobile phone system in FIG. 13 and that in FIG. 18 is the mobile phone system in FIG. 13 comprises an image sensor module 1307 for capturing images and an image processor 1310 for processing images. Other components in FIG. 13 having the same reference numbers as those in FIG. 18 have the same functions, and the description for those components is omitted for avoiding redundancy.

The image sensor module 1307 captures images by focusing incoming light via the lens 1308 onto the image sensor 1309, which outputs the raw image data to the image processor 1310. The image processor 1310 has a timing generator unit 1311 generating some image sensor control signals based on timing settings configured by the processor 1305, and one of the timing settings is the exposure time of the sensor that is controlled by the exposure time setting register 1314. The processor 1305 can change the exposure time by programming the exposure time setting register 1314. Images processed and reconstructed by the image processor 1310 are compressed by an image compressor 1312 to reduce the data sizes. Eventually the compressed image data is stored to the memory 1306, or another storage media 1313, again under the control of the processor 1305.

Similarly, the GPS Receiver 1320 and the GPS antenna 1321 are optional in the system of FIG. 13. If they exist, the processor 1305 uses the coordinate data outputted by the GPS receiver 1320 to control the camera setting according to the coordinate data.

Similarly, in the system of FIG. 13, country or location information can be obtained from the GSM cellular network using the GSM Communication unit 1301 or from the GPS satellites via the GPS antenna 1321 and the GPS receiver 1320.

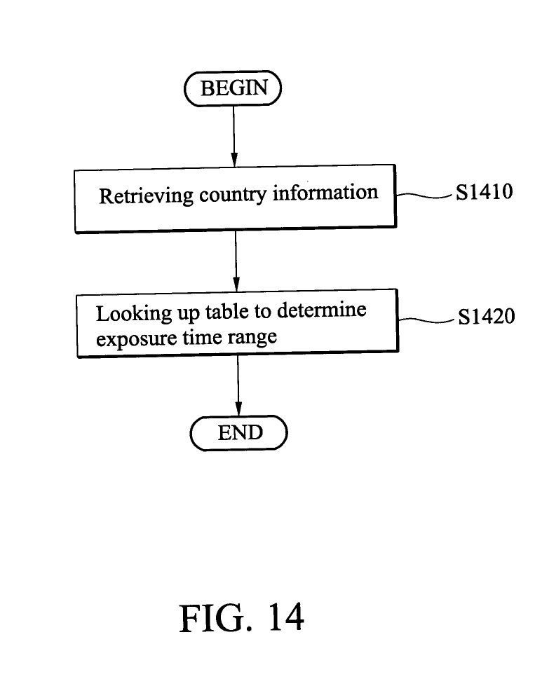

FIG. 14 is a flowchart showing an embodiment of a method for determining exposure timing in the system shown in FIG. 13. In step S1410, country information is retrieved. It is understood that the country information can be retrieved according to the location area identifier (referring to FIG. 4 and FIG. 5) or the position information of the device 210 (referring to FIG. 6), and is not limited thereto. In step S1420, a lamp flicker frequency table is looked up according to the country information, and the exposure time is set to a multiple of the reciprocal of the located lamp flicker frequency. It is understood that the timing for setting the exposure time can be the time when the country information is received as the device camps on a communication network or as the device obtains position information by receiving signals from the GPS satellite, or the time when the image capture function (i.e. camera function) is enabled. In some embodiments, the user can make the setting time selection and trigger the setting of exposure time via interface of the device 110/210.

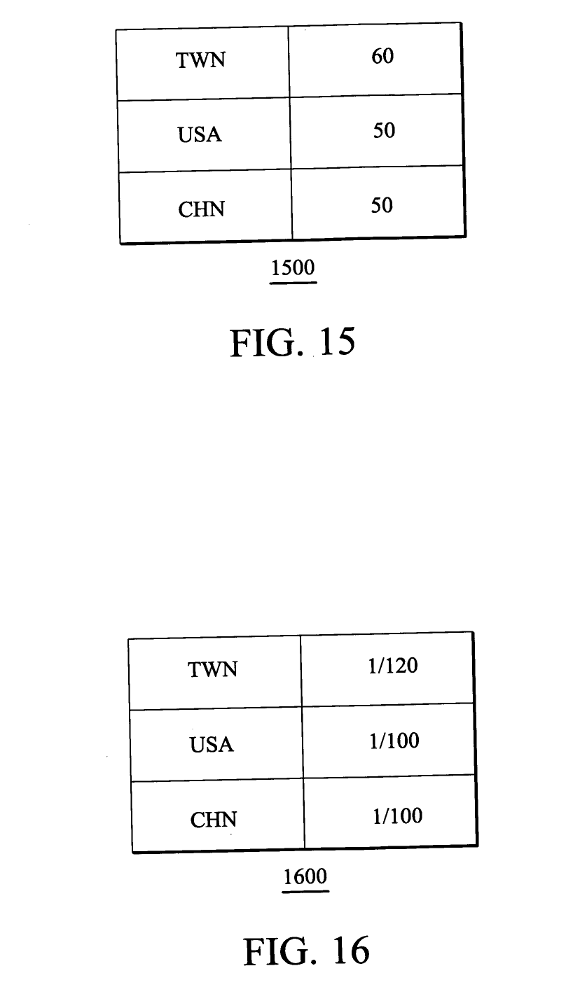

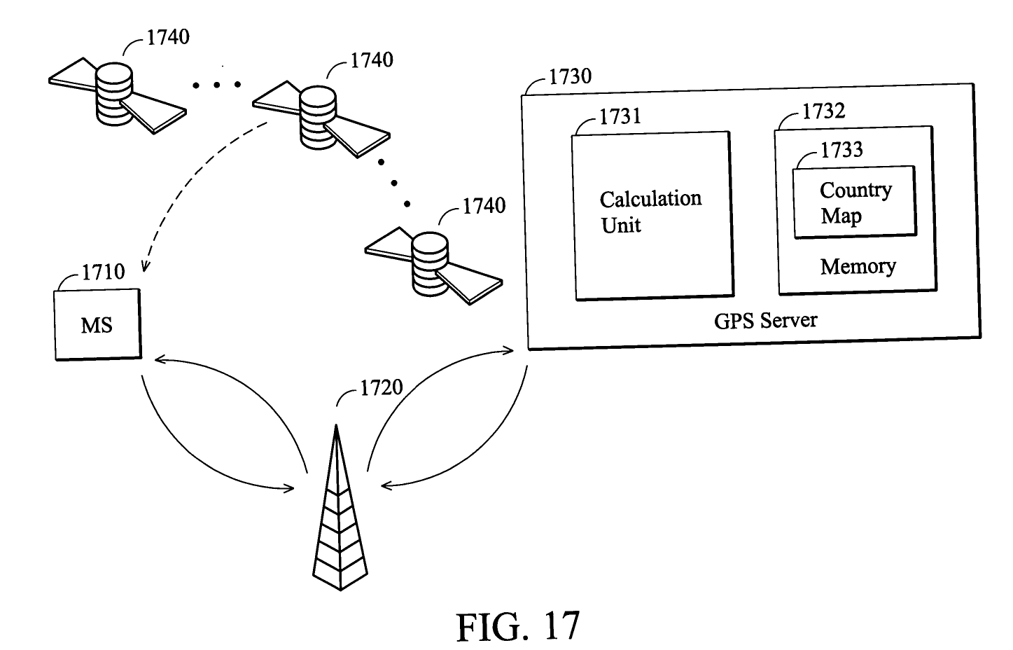

FIG. 15 is a schematic diagram illustrating an embodiment of a fluorescent lamps frequency table 1500. The table 1500 comprises a plurality of first fields for strong country codes, and a plurality of second fields. Each of the second fields corresponds to a first field for storing the fluorescent lamps frequency of the fluorescent lamp used in the country represented by the corresponding country code. As shown in FIG. 15, the fluorescent lamps frequencies for Taiwan (TWN), America (USA) and China (CHN) are 60, 50 and 50 HZ, respectively. Therefore, the exposure time for Taiwan (TWN), America (USA) and China (CHN) can be set to multiples of 1/120, 1/100 and 1/100 seconds, respectively. In some embodiments, an exposure time table 1600 is provided in the device. As shown in FIG. 16, for example, the exposure time table 1600 directly stores the exposure time for Taiwan (TWN), America (USA) and China (CHN) as 1/120, 1/100 and 1/100 seconds, respectively.

It is understood that if several fluorescent lamps frequencies are used in a country, all the fluorescent lamps frequencies may be stored in the table, and the most commonly used frequency can be set as a default. In some embodiments, the device 110 may show all of the acceptable fluorescent lamps frequencies on the interface for user selection. Further, if several fluorescent lamps frequencies are respectively used in areas of a country, the specific fluorescent lamps frequency of one area can be located from a table recording respective areas and corresponding fluorescent lamps frequencies according to the position information generated by the GPS receiver 213 of the device 210. It is also understood that if no GPS signal is received, the previous position information can be used for locating fluorescent lamps frequency. In some embodiments, if no GPS signal is received, the system information from BCCH can be used for locating fluorescent lamps frequency. After setting the exposure time corresponding to the located fluorescent lamps frequency, the accumulated exposure energies for A and B are equalized, thus eliminating the banding situation.

Image sensors not using rolling shutter (e.g. mechanical shutter) may expose all its pixels at the same time thus are free of banding. When such a sensor captures images continuously very quickly, the flicker of light source could cause uneven brightness of the captured images. The presented invention can also apply to sensors.

It should be understood that not only the operation setting can be determined according to the obtained country information/position information, but also some country/area related information can be provided according to the same. For example, the voltage information and/or circulated currency regarding to the country/area represented by the obtained country information/position information can be provided when the user travels to different countries/areas.

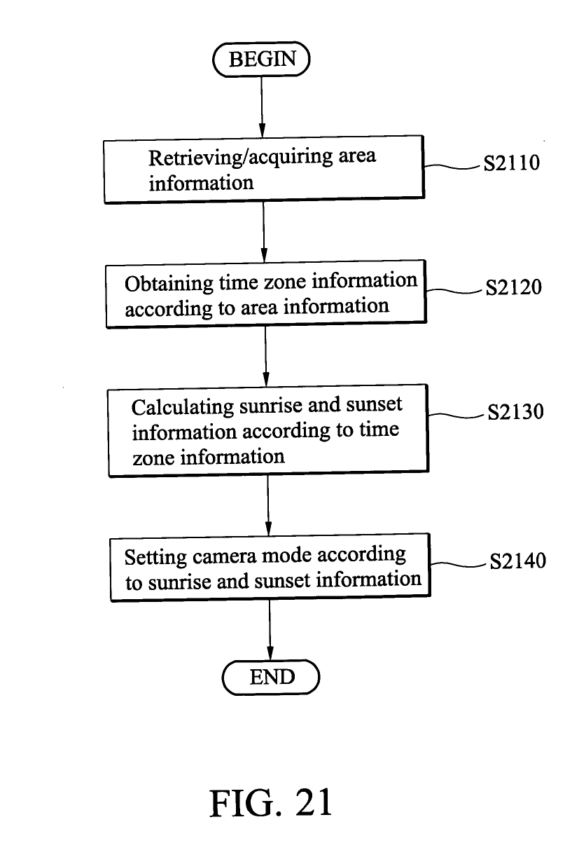

As for the device 210 having the GPS receiver 213, an automatic operational setting of camera mode can be provided. FIG. 21 is a flowchart showing an embodiment of a method for setting camera mode. It is understood that a table is provided in the device 210. The table comprises a plurality of first fields for recording area information, such as country information, and a plurality of second fields. Each of the second fields corresponds to one first field, for recording time zone information. First, in step S2110, area information currently located by the device 210 is retrieved. In step S2120, time zone information is obtained by looking up the table according to the area information. According to the position information, i.e. the longitude and latitude of the device 210, the time zone where the device 210 is located can be obtained. In step S2130, sunrise and sunset information is calculated according to the time zone information. In step S2140, the camera mode of the device 210 is set according to the sunrise and sunset information. The device 210 can base on the system time and the sunrise/sunset time information to decide whether it is daytime or not. If it is daytime, the camera will be automatically set as day shot mode, and if it is night time, the camera will be automatically set as night shot mode. It can be easily understood that the automatic camera mode setting can be overridden by the manual camera setting of the user via the interface of the device 210.

Methods for determining operational settings, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in- this technology can still make various alterations and modifications without departing from the scope and spirit of this invention. Therefore, the scope of the present invention shall be defined and protected by the following claims and their equivalents.

What is claimed is:

1. A method for determining operational settings for use in a device, comprising:
retrieving first country information on the device; and
determining an operational setting of a function on the device based on the first country information.

2. The method of claim 1 further comprising:
listening to a control channel provided by a communication network, and receiving system information of the communication network from the control channel, in which the system information comprises a location area identifier; and
retrieving the first country information from the location area identifier.

3. The method of claim 1 further comprising:
receiving a location area identifier during a location update procedure between the device and a communication network; and
retrieving the first country information from the location area identifier.

4. The method of claim 1 further comprising:
receiving signals, and generating position information of the device accordingly; and
identifying the first country information according to the position information of the device.

5. The method of claim 1 further comprising receiving a setting of the first country information via an interface of the device.

6. The method of claim 1 further comprising:
receiving a city information setting via an interface of the device; and
identifying the first country information according to the city information.

7. The method of claim 1 further comprising determining an output signal format based on the first country information.

8. The method of claim 1 further comprising:
providing a second country information previously located by the device;
calculating a time difference based on the first and second country information; and
adjusting a system time of the device based on the time difference.

9. The method of claim 1 further comprising:
providing a second country information previously located by the device; and
determining an exchange rate based on the first and second country information.

10. The method of claim 1 further comprising determining an exposure time for capturing lines of an image based on the first country information.

11. A device, comprising:
means for retrieving first country information; and
means for determining an operational setting of a function on the device based on the first country information.

12. The device of claim 11 further comprising:
means for listening to a control channel provided by a communication network, and receiving system information of the communication network from the control channel, in which the system information comprises a location area identifier; and
means for retrieving the first country information from the location area identifier.

13. The device of claim 11 further comprising:
means for receiving a location area identifier during a location update procedure between the device and a communication network; and
means for retrieving the first country information from the location area identifier.

14. The device of claim 11 further comprising:
means for receiving signals, and generating position information of the device accordingly; and
means for identifying the first country information according to the position information of the device.

15. The device of claim 11 further comprising:
means for receiving a setting of the first country information via an interface of the device.

16. The device of claim 11 further comprising:
means for receiving a city information setting via an interface of the device; and
means for identifying the first country information according to the city information.

17. The device of claim 11 further comprising:
means for determining an output signal format based on the first country information.

18. The device of claim 11 further comprising:
means for providing a second country information previously located by the device;
means for calculating a time difference based on the first and second country information; and
means for adjusting a system time of the device based on the time difference.

19. The device of claim 11 further comprising:
means for providing a second country information previously located by the device; and
means for determining an exchange rate based on the first and second country information.

20. The device of claim 11 further comprising:
means for determining an exposure time for capturing lines of an image based on the first country information.

21. A method for determining output signal format of a function for use in a device, comprising:
providing a table comprising a plurality of first fields for recording country information and a plurality of second fields, each of which being corresponding to one first field, for recording output signal formats;
retrieving country information on the device; and
determining an output signal format of a function on the device based on the country information by looking up the table.

22. A method for determining exposure time of an image capturing function for use in a device, comprising:
providing a table comprising a plurality of first fields for recording country information and a plurality of second fields, each of which being corresponding to one first field, for recording exposure time;
retrieving country information on the device; and
determining an exposure time of the image capturing function on the device based on the country information by looking up the table.

23. A method for adjusting system time for use in a device, comprising:
providing a table comprising a plurality of first fields for recording area information and a plurality of second fields, each of which being corresponding to one first field, for recording time zone information;
retrieving a first area information currently located by the device;
providing a second area information previously located by the device;
obtaining a first time zone information -for the first area information and a second time zone information for the second area information by looking up the table;
calculating a time difference based on the first and second time zone information; and
adjusting the system time of the device based on the time difference.

24. A method for setting camera mode for use in a device, comprising:
providing a table comprising a plurality of first fields for recording area information and a plurality of second fields, each of which being corresponding to one first field, for recording time zone information;
retrieving area information currently located by the device;
obtaining time zone information by looking up the table;
obtaining sunrise and sunset information according to the time zone information; and
setting the camera mode according to the sunrise and sunset information.

25. A method for acquiring country/area related information for use in a device connected to a communication network, comprising:
providing a table comprising a plurality of first fields for recording country/area information and a plurality of second fields, each of which being corresponding to one first field, for recording country/area related information;
receiving system information from the communication network;
retrieving country/area information currently located by the device from the system information; and
acquiring country/area related information based on the country/area information by looking up the table.

26. A method for acquiring country/area related information for use in a device capable of receiving GPS (Global Positioning System) signals from a GPS satellite, comprising:
providing a table comprising a plurality of first fields for recording country/area information and a plurality of second fields, each of which being corresponding to one first field, for recording country/area related information;
receiving GPS signals from the GPS satellite and calculating position information regarding to the device;
acquiring country/area information currently located by the device based on the position information; and
acquiring country/area related information based on the country/area information by looking up the table.

27. A system, comprising:
a GPS (Global Positioning System) satellite broadcasting GPS signals;
a MS (Mobile Station) receiving the GPS signals from the GPS satellite, and sending out the GPS signals; and
a GPS server receiving the GPS signals, calculating position information accordingly, determining country information according to the position information, and sending the country information to the MS.

28. The system of claim 27 wherein the MS sends the GPS signals to the GPS server via a base station.

29. The system of claim 28 wherein data transmission between the base station and the GPS server is through an Internet or a cellular network.

30. The system of claim 27 wherein the MS sends the GPS signals to the GPS server via an Internet using a wireless communication technology.

31. A mobile station, comprising:
a communication unit listening to a control channel provided by a communication network, and receiving system information of the communication network from the control channel; and
a processor retrieving country information from the system information, and determining an exposure time for capturing lines of an image based on the country information.

32. A device, comprising:
a GPS (Global Positioning System) antenna;
a GPS receiver receiving and decoding the positioning signals broadcasted by GPS satellites via the GPS antenna, and calculating position information accordingly; and
a processor retrieving country information according to the position information, and determining an exposure time for capturing lines of an image based on the country information.

33. A mobile station, comprising:
a communication unit listening to a control channel provided by a communication network, and receiving system information of the communication network from the control channel; and
a processor retrieving country information from the system information, and determining an operational setting of a function on the mobile station based on the country information.

34. A device, comprising:
a GPS (Global Positioning System) antenna;
a GPS receiver receiving and decoding the positioning signals broadcasted by GPS satellites via the GPS antenna, and calculating position information accordingly; and
a processor retrieving country information according to the position information, and determining an operational setting of a function on the mobile station based on the country information.
